(19) United States
(12) Patent Application Publication
(10) Pub. No.: US 2023/0379279 A1
(43) Pub. Date: Nov. 23, 2023

(54) INTERACTION METHOD AND APPARATUS, AND ELECTRONIC DEVICE

(71) Applicant: BEIJING ZITIAO NETWORK TECHNOLOGY CO., LTD., Beijing (CN)

(72) Inventor: Fangjia CHEN, Beijing (CN)

(21) Appl. No.: 18/361,493

(22) Filed: Jul. 28, 2023

Related U.S. Application Data
(63) Continuation of application No. PCT/CN2022/072461, filed on Jan. 18, 2022.

(30) Foreign Application Priority Data
Jan. 29, 2021 (CN) 202110133747.4

(51) Int. Cl. H04L 51/04; H04L 12/18

(52) U.S. Cl. CPC H04L 51/04; H04L 12/18

(57) ABSTRACT

Embodiments of the present disclosure disclose an interaction method and apparatus, and an electronic device. A specific implementation means of the method comprises: in response to detecting a predefined group member addition operation, displaying an organization identity, the organization identity being used for indicating an organization architecture; on the basis of a selection operation for the organization identity, determining a group member unit of a first group, the group member unit being a management unit that manages members in the first group; and on the basis of the determined group member unit, generating the first group, first group members of the first group comprising organization members that are associated with the group member unit. Thus, a new means of interaction can be provided.

The present application is a continuation of International Patent Application No. PCT/CN2022/072461 filed on Jan. 18, 2022, which claims the priority to Chinese Patent Application No. 202110133747.4, titled “INTERACTION METHOD AND APPARATUS, AND ELECTRONIC DEVICE”, filed on Jan. 29, 2021 with the Chinese Patent Office, both of which are incorporated herein by reference in their entireties.

### FIELD

The present disclosure relates to the technical field of Internet, and in particular to an interaction method, an interaction apparatus, and an electronic device.

### BACKGROUND

With the development of the Internet, more and more users use terminal devices to perform various functions. For example, the user may communicate with others through a terminal device.

In some application scenarios, an instant messaging application may be installed in a terminal device. The user, by using the instant messaging application, may chat with others individually or perform information interaction in a group.

### SUMMARY

The content part of the present disclosure is provided to introduce concepts in a brief form, and these concepts are to be described in detail in the following embodiments. The content of the present disclosure is not intended to identify the key features or essential features of the claimed technical solutions, nor is it intended to be used to limit the scope of the claimed technical solutions.

In a first aspect, an interaction method is provided according to an embodiment of the present disclosure. The method includes: in response to detecting a predefined group member addition operation, displaying one or more organization identity, where the organization identity indicates an organization structure; based on a selection operation for the organization identity, determining a group member unit for a first group, where the group member unit is a management unit for managing first group members in the first group; and based on the determined group member unit, generating the first group, where the first group members of the first group include organization members associated with the group member unit.

In a second aspect, an interaction method is provided according to an embodiment of the present disclosure. The method includes: in response to detecting a predefined group member addition operation, displaying a group candidate object, where the group candidate object includes a user group identity, and the user group identity indicates a user set including at least two users; and based on a selection operation for the group candidate objects, determining one or more selected user groups, and generating a first group based on the selected user groups.

In a third aspect, an interaction apparatus is provided according to an embodiment of the present disclosure. The apparatus includes: a displaying unit, a determination unit, and a generation unit. The displaying unit is configured to display one or more organization identity in response to detecting a predefined group member addition operation, where the organization identity indicates an organization structure. The determination unit is configured to, based on a selection operation for the organization identity, determine a group member unit for a first group, where the group member unit is a management unit for managing first group members in the first group. The generation unit is configured to, based on the determined group member unit, generate the first group, where the first group members of the first group include organization members associated with the group member unit.

In a fourth aspect, an interaction apparatus is provided according to an embodiment of the present disclosure. The apparatus includes: a displaying module and a determination module. The displaying module is configured to, in response to detecting a predefined group member addition operation, display a group candidate object, where the group candidate object includes a user group identity, and the user group identity indicates a user set including at least two users. The determination module is configured to, based on a selection operation for the group candidate objects, determine one or more selected user groups, and generate a first group based on the selected user groups.

In a fifth aspect, an electronic device is provided according to an embodiment of the present disclosure. The electronic device includes one or more processors and a memory. The memory stores one or more programs. The one or more programs, when executed by the one or more processors, causes the one or more processors to perform the interaction method provided in the first aspect or the interaction method provided in the second aspect.

In a sixth aspect, a computer-readable medium is provided according to an embodiment of the present disclosure. The computer-readable medium storage stores a computer program. The computer program, when executed by a processor, causes the processor to perform the interaction method provided in the first aspect or the interaction method provided in the second aspect.

With the interaction method, the interaction apparatus, and the electronic device according to the embodiments of the present disclosure, in response to detecting a group member addition operation, an organization identity is displayed. Then, the user may select an organizational identity and determine a group member unit. Based on the determined group member unit, first group members may be determined, and a group may be generated or updated.

Thus, a new group generation mode is provided. In the new group generation mode, the user may select an organization, and then add the organization, as a group member unit, to a first group. That is, group members are added with an organization as a unit. Therefore, organizations may be effectively integrated, and transaction communication may be coordinated among several organizations. For transactions required to be performed with an organization as a unit, communication efficiency can be improved.

In addition, group members may be added in bulk by selecting an organization, reducing operations due to individually selecting organization members, saving the user the number of operations and time required to select candidate users in generating a group, and improving operation efficiency.

### BRIEF DESCRIPTION OF THE DRAWINGS

The above and other features, advantages and aspects of the embodiments of the present disclosure will be more apparent in conjunction with the accompanying drawings and with reference to the following embodiments. Throughout the drawings, the same or similar reference numerals represent the same or similar elements. It should be understood that the drawings are schematic and the originals and elements are unnecessarily drawn to scale.

FIG. 1 is a flow chart of an interaction method according to an embodiment of the present disclosure;

FIG. 2 and FIG. 3 are schematic diagrams of application scenarios of an interaction method according to the present disclosure;

FIG. 4 is a schematic diagram of an exemplary implementation of an interaction method according to the present disclosure;

FIG. 5 is a flow chart of an interaction method according to another embodiment of the present disclosure;

FIG. 6 is a schematic structural diagram of an interaction apparatus according to an embodiment of the present disclosure;

FIG. 7 is a schematic structural diagram of an interaction apparatus according to another embodiment of the present disclosure;

FIG. 8 shows an exemplary system architecture to which an interaction method according to an embodiment of the present disclosure may be applied; and

FIG. 9 is a schematic structural diagram of an electronic device according to an embodiment of the present disclosure.

### DETAILED DESCRIPTION OF THE EMBODIMENTS

The embodiments of the present disclosure are described in detail below with reference to the accompanying drawings. Although the drawings show some embodiments of the present disclosure, it should be understood that the present disclosure can be implemented in various forms and is not limited to the embodiments. The embodiments are provided for a more thorough and complete understanding of the present disclosure. It should be understood that the drawings and the embodiments in the present disclosure are only illustrative of the disclosure, and are not intended to limit the protection scope of the present disclosure.

It should be understood that the steps of the method according to the embodiments of the present disclosure may be performed in different orders, and/or be performed in parallel. In addition, the method embodiments may include additional steps and/or omit to perform the illustrated steps, not limiting the scope of the present disclosure.

The term “including” and its variants as used herein are open-ended includes, that is, “including but not limited to”. The term “based on” means “based at least in part on.” The term “one embodiment” means “at least one embodiment”. The term “another embodiment” means “at least one additional embodiment”. The term “some embodiments” means “at least some embodiments”. Definitions of other terms are provided in the following description.

It should be noted that, the terms “first” “second” and so on mentioned in the present disclosure are only used to distinguishing different apparatuses, modules or units, rather than limit an order of functions performed by the apparatus, module or unit or limit interdependence.

It should be noted that, the terms “one” and “multiple” mentioned in the present disclosure are schematic rather than restrictive, and should be understood as “one or more” by those skilled in the art, otherwise explicitly illustrated in the context.

The names of messages or information exchanged between multiple devices in the embodiments of the present disclosure are only illustrative, and are not intended to limit the scope of the messages or information.

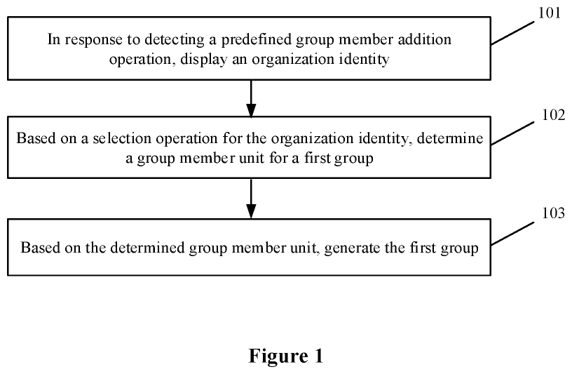

Reference is made to FIG. 1, which shows a flow chart of an interaction method according to an embodiment of the present disclosure. As shown in FIG. 1, the interaction method includes the following steps 101 to 103.

In step 101, in response to detecting a predefined group member addition operation, one or more organization identity is displayed.

In the embodiment, an executing body (such as a terminal device and/or a server) of the interaction method may display an organization identity in response to detecting a predefined group member addition operation.

In the embodiment, the group member addition operation may be understood as an operation of displaying candidate objects that may be added to a group before adding a group member. That is, the group member addition operation may indicate a candidate to-be-added object for a first group.

How to perform the group member addition operation may be configured according to actual application scenarios.

As an example, a group conversation interface may include a group member addition control. A trigger operation for the group member addition control may be understood as the group member addition operation.

As an example, a user interface of an instant messaging application may display a group generation control. A trigger operation for the group generation control may be understood as the group member addition operation.

In the embodiment, the organization identity may indicate an organization structure. Due to that an organization structure may generally be represented as a tree like structure, the organization structure may also be referred to as an organization structure tree. The organization structure tree may be a group form of an organization generated by an enterprise-end (B-end) user. In an embodiment, the organization identity may include but is not limited to one of: an organization name, an organization code, and an organization icon.

In the embodiment, the organization structure may include organization members. As an example, a company A may include a department A and a department B. The department A may include 10 organization members. The department B may include 5 organization members. The organization structure corresponding to the company A may include the organization structure (including 10 organization members) of the department A and the organization structure (including 5 organization members) of the department B.

In step 102, based on a selection operation for the organization identity, a group member unit for a first group is determined.

In the embodiment, the executing body may determine a group member unit of a first group based on a selection operation for the organization identity.

The first group may be a group to which the user added a group member. The first group may be a generated group or a group being generated.

The user may perform a selection operation on the organization identity, and determines an organization, indicated by a selected organization identity, as the group member unit of the first group.

The group member unit may indicate a user unit to be added to the group. The group member unit may be a management unit for managing first group members in the first group. That is, the group member unit may be understood as a unit for managing users. The users may be added, deleted, or updated in batches with the group member unit as the unit.

In some application scenarios, the group member unit may include but is not limited to: a user, a group, and an organization.

In step 103, based on the determined group member unit, the first group is generated.

In the embodiment, the executing body may generate the first group based on the determined group member unit.

In the embodiment, the first group members may be users in the group. It should be understood that the members in a group may include users such as a user Zhang San or a user Li Si.

In the embodiment, the first group members of the first group may include organization members associated with the group member unit. The first group members may be determined based on the group member unit. That is, organization members in the determined group member unit (such as an organization structure) may be determined as the first group members.

A group may be generated by, but not limited to, performing at least one of: adding a new member to a generated group, and generating a new group with the determined first group member as elements.

It should be noted that with the interaction method according to the embodiment, in response to detecting a group member addition operation, an organization identity is displayed; then the user may select an organizational identity to determine a group member unit; and then, based on the determined group member unit, first group members are determined, and a group may be generated or updated.

Thus, a new group generation mode is provided. In the new group generation mode, the user may select an organization, and then add the organization, as a group member unit, to a first group. That is, group members are added with an organization as a unit. Therefore, organizations may be effectively integrated, and transaction communication may be coordinated among several organizations. For transactions required to be performed with an organization as a unit, communication efficiency can be improved.

In addition, group members may be added in bulk by selecting an organization, reducing operations due to individually selecting organization members, saving the user the number of operations and time required to select candidate users in generating a group, and improving operation efficiency.

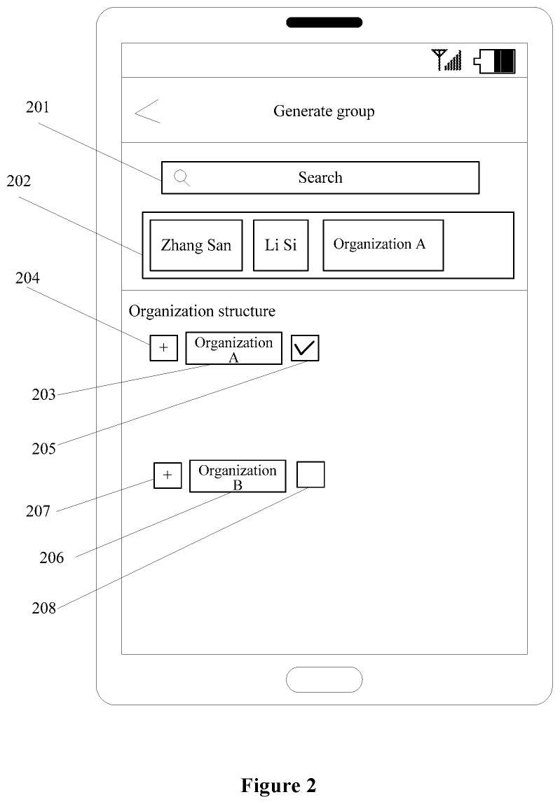

Reference is made to FIG. 2, which shows an exemplary application scenario of the interaction method according to the embodiment shown in FIG. 1. FIG. 2 shows a group generation scenario in which the user selects group members for a to-be-generated group in an exemplary interface. In the interface shown in FIG. 2, a search control 201 may be configured to search for a candidate member unit. In a first region 202, the group member unit of the first group may be displayed. As an example, Zhang San displayed in the first region 202 may be a group member unit, Li Si displayed in the first region 202 may be a group member unit, and organization A displayed in the first region 202 may be a group member unit.

In the exemplary interface, candidate addition objects may be displayed. For example, an organization A identity 203 and an organization B identity 206 may be displayed.

As an example, a first expansion control 204 associated with the organization A identity 203 may be arranged, and a first expansion control 205 associated with the organization A identity 205 may be further arranged. A second expansion control 207 associated with an organization B identity 206 may be arranged, and a second expansion control 208 associated with the organization B identity 206 may be further arranged.

In some embodiments, the step 103 may include an operation of adding all the organization members associated with the determined group member unit to the first group.

All the organization members of the determined group member unit may be determined as the first group members.

As an example, the determined group member unit may include the organization A. The organization A may include Zhang San and Li Si, so Zhang San and Li Si may be determined as the group members.

As an example, the determined group member unit may include the organization A and an organization C. In a case that both the organization A and the organization C include the user Zhang San, then Zhang San may be labeled as organization A and organization C, and then the user Zhang San is added to the first group as a member.

It should be noted that compared to selecting organization members one by one, with the operation of determining all the organization members of the group member unit as members of the first group, the efficiency of determining group candidate members can be improved.

In some embodiments, the step 102 may include an operation of establishing an association relationship between the selected organization identity and the first group. That is, an association relationship may be established between the group member unit of the first group and the first group.

In some embodiments, the method further includes: updating the first group members in the first group based on updating the organization members associated with the group member unit.

As an example, the first group may be associated with an organization identity A and an organization identity B. For the organization A as a group member unit of the first group, in a case that the organization members associated with the organization A are updated, the group members in the first group may be updated based on the updating of the organization members in the organization A.

That is, the organization A is added to the first group as a whole. In a case that a new organization member is added to the organization A or an organization member is deleted from the organization A, the first group may be updated based on the updating of the organization members in the organization A.

It should be noted that in a case that the organization members in the group member unit change, the first group may be automatically updated, thereby automatically updating the first group, omitting the step of manually adjusting the first group members in the case that the organization members change, and improving the accuracy of the first group members. Furthermore, the barrier mentality of manually kicking a user out of a group is avoided, and consistency between the group members and the organizational members is ensured through technical means, improving the accuracy of group members.

In some embodiments, the step of updating the first group members in the first group based on updating the organization members associated with the group member unit may include: in response to adding an organization member to the organization members associated with group member unit, determining the added organization member as a first group member of the first group.

As an example, in a case that a new organization member Ma Ba is added to the organization A, Ma Ba may be added to the first group.

As an example, in a case that a new organization member Zhang San is added to the organization C, Zhang San may be determined as a group member, and then it is determined whether Zhang San is already in the first group. In a case that Zhang San is not in the first group, Zhang San may be determined as a group member. In a case that Zhang San is already in the first group, it is unnecessary to add Zhang San to the first group.

It should be noted that when adding a new member to an organization, the group members in the first group are synchronously updated, automatically updating the first group based on the newly added member in the organization.

In some embodiments, the step of updating the first group members in the first group based on updating the organization members associated with the group member unit may include: in response to deleting an organization member from the organization members associated with group member unit, determining whether to delete the deleted organization member from the first group based on the group member unit of the first group associated with the reduced organization member.

As an example, in a case that the user Zhang San is deleted from the organization A, it may be determined whether to delete Zhang San from the first group based on the group member unit, associated with Zhang San, of the first group.

It should be noted that when deleting a member from an organization, based on the group member unit associated with the deleted member, it may be determined from multiple perspectives whether to remain the deleted user, that is added to the first group in multiple modes, in the first group, avoiding a situation in which a user cannot be interacted with in the first group due to that the user has been deleted.

In some embodiments, the step of in response to deleting an organization member from the organization members associated with group member unit, determining whether to delete the deleted organization member from the first group based on the group member unit of the first group associated with the deleted organization member includes: in response to determining that the deleted organization member is associated with a remaining group member unit of the first group, retaining the deleted organization member in the first group.

As an example, Zhang San may be added to a group through the organization A and the organization C. In a case that Zhang San has been deleted from the organization A and Zhang San is still in the organization C, if the organization C is still a group member unit of the first group, Zhang San may be retained in the first group.

It should be noted that in a case that a deleted organization member is associated with a remaining group member of the first group, the deleted organization member is not deleted, avoiding a situation in which the deleted member is deleted from the first group while the deleted member is still in a group member unit of the first group. Thus, the accuracy of the group members in the first group is ensured.

In some embodiments, the step of in response to deleting an organization member from the organization members associated with group member unit, determining whether to delete the deleted organization member from the first group based on the group member unit of the first group associated with the deleted organization member includes: in response to determining that the deleted organization member is not associated with a group member unit of the first group, determining whether the deleted organization member is added to the first group in a first addition mode; in a case that the deleted organization member is added to the first group in the first addition mode, retaining the deleted organization member in the first group; and in a case that the deleted organization member is not added to the first group in the first addition mode, deleting the deleted organization member from the first group.

As an example, in a case that the organization C is no longer a group member unit of the first group, that is, Zhang San is not associated with a group member unit of the first group, it may be determined whether Zhang San is added to the first group in a first addition mode. In a case that Zhang San is not added to the first group in the first addition mode, Zhang San may be deleted from the first group.

It should be noted that in a case that a user is not added to a group in the first addition mode and does not belong to any group member unit of the first group, it indicates that it is unnecessary to keep the user in the first group. In this case, the user should be deleted from the first group, preventing information leakage from the first group.

It should be noted that in a case that a user does not belong to any group member unit of the first group and the user is added to the group in the first addition mode, it indicates, by the addition mode of the user, that even if the user is deleted from the organization, the user should still remained in the first group. Therefore, in this case, the user should be remained in the first group, avoiding inefficient information exchange in the first group due to the user being unable to participate in the first group.

In some embodiments, the step of in response to deleting an organization member from the organization members associated with group member unit, determining whether to delete the deleted organization member from the first group based on the group member unit of the first group associated with the deleted organization member includes: in response to deleting the organization member from the organization members associated with group member unit, determining whether the deleted organization member is added to the first group in a first addition mode; in a case that the deleted organization member is added to the first group in the first addition mode, retaining the deleted organization member in the first group; and in a case that the deleted organization member is not added to the first group in the first addition mode, determining whether to delete the deleted organization member from the first group based on the group member unit of the first group associated with the deleted organization member.

As an example, Zhang San is deleted from the organization A. Then, it may be determined whether Zhang San is added to the first group in a first addition mode. In a case that Zhang San is added to the first group in the first addition mode, Zhang San is remained in the first group. In a case that Zhang San is not added to the first group in the first addition mode, it is determined whether Zhang San is associated with an organization (such as organization C) in the first group.

Therefore, a step of comparing a deleted organization member with each of organization member units can be omitted, and it is quickly determined whether to delete the deleted organization member from the first group.

In some embodiments, the first addition mode in which a member is added to the first group includes at least one of: a mode in which a member is added to the first group based on selecting a user identity; and a mode in which based on selecting a second group identity, a second group member associated with the second group identity is added to the first group.

The mode in which a member is added to the first group based on selecting a user identity may be understood as adding a member to the first group in a single pulling mode. As an example, a current user may check the identity of Zhang San to add Zhang San to the first group.

The mode in which based on selecting a second group identity, a second group member associated with the second group identity is added to the first group may be understood as adding a member to the first group by selecting a group. As an example, a current user may check a second group identity, and then all members corresponding to the second group identity may be added to the first group.

It should be noted that adding a member to a group in the first addition mode may reflect diversity of adding users to the first group. The user, being added to the first group in multiple modes, may be necessary for the first group. Therefore, the first addition mode is verified to avoid mistakenly deleting an important first group member.

In some embodiments, the method further includes at least one of: determining a trigger operation for a group generation control as the group member addition operation; determining a new member search operation for a generated group as the group member addition operation; and determining a new member addition operation for the generated group as the group member addition operation.

The group generation control may be configured to initiate generating a group. When generating a group, it is necessary to select group members. Therefore, the trigger operation for the group generation control is determined as the group member addition operation, improving the efficiency of the user selecting group members for group generation and improving the speed of group generation.

The new member search operation for a generated group may be performed to trigger displaying a new member addition interface in an interface of the generated group. Then, the new member addition interface may display a search control. The search control is configured to search for a group candidate object. The user may enter an input, such as “Zhang San”, in the search control. Then, the user Zhang San may be displayed, or an organization identity, such as an organization identity A, associated with Zhang San may be displayed.

It should be noted that an organization identity is displayed in performing the new member search operation, then the user may be provided with rich and accurate group candidate objects, omitting a step for the user to search for an object to be added to the first group, and improving the speed and accuracy of determining group members for the first group.

A new member addition interface may be displayed in the interface of the generated group, and the new member addition interface may display the organization identity. Therefore, it is convenient for the user to add group members with an organization as a unit based on the organization identity, omitting a step for the user to search for an object to be added to the first group.

In some embodiments, the method may further include: displaying an organization member identity associated with the organization identity; and in response to detecting a selection operation for the organization member identity, determining a selected organization member as a group candidate member.

An organization member identity associated with the organization identity may be selected. Then, an organization member may be directly determined as a group candidate member.

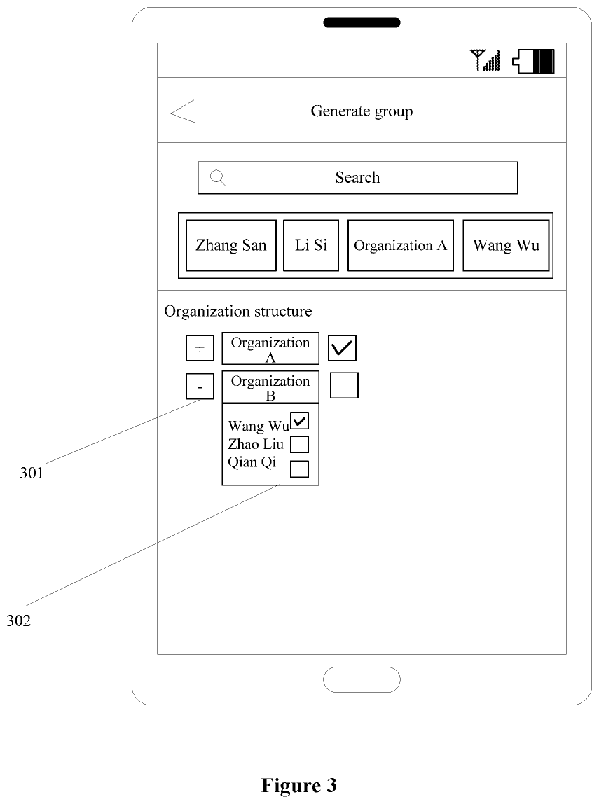

Reference is made to FIG. 3, which shows a schematic diagram of selecting an organization member. The user may perform a click operation on a second display control shown in FIG. 2. Then, an interface as shown in FIG. 3 may be displayed. In FIG. 3, a folding control 301 and an organization member display region 302 may be displayed. In the organization member display region 302, organization members, such as Wang Wu, Zhao Liu, and Qian Qi, of the organization B may be displayed. In addition, Wang Wu may be associated with a display selection control, Zhao Liu may be associated with a display selection control, and Qian Qi may be associated with a display selection control. As an example, the user may determine Wang Wu as a group member. In a group member unit display region shown in FIG. 3, an identity of the user Wang Wu may be displayed.

It should be noted that the organization member identity is displayed, and then the organization member is selected, thus a single user in an organization is pulled to a group. Therefore, in a case that the current user expects to pull a user from the organization to the group to participate discussion and the user is not a friend listed in the address book of the current user, the organization member is displayed, and then the user is pulled to the group, omitting a step for the current user to add the user as a friend and then pull the user to the group, thereby improving the speed of adding a group member to the group.

In some embodiments, the step 103 may include at least one of: generating the first group; and adding a new first group member to the generated first group.

In generating a new group, an organization identity is displayed, and the group is generated based on determined group members, thereby realizing rapid group generation.

In adding a new member to a generated group, an organization identity is displayed, and determined group members are added to the generated group, thereby quickly adding a member of the organization structure to the generated group, and improving the information exchange efficiency of the generated group.

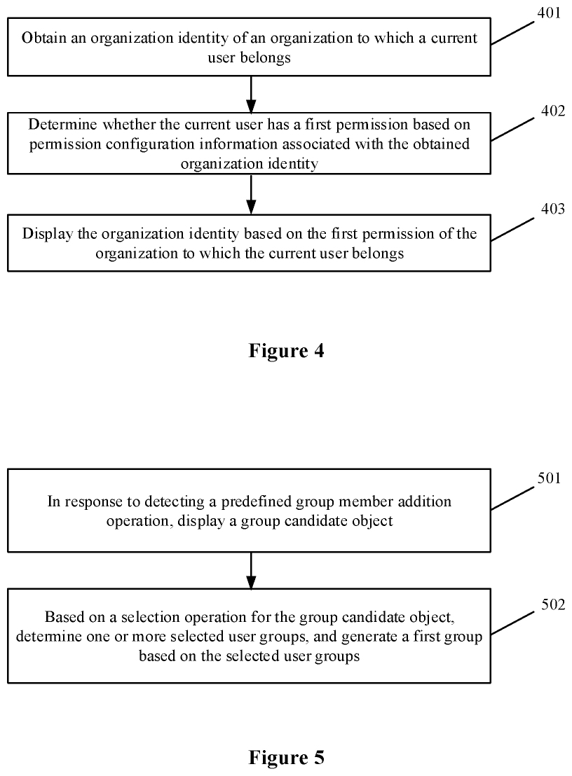

In some embodiments, the step 101 may include the process shown in FIG. 4.

As shown in FIG. 4, the process shown in FIG. 4 may include the following steps 401, 402, and 403.

In step 401, an organization identity of an organization to which a current user belongs is obtained.

The current user may be a user that logs in to an instant application.

In step 402, it is determined whether the current user has a first permission based on permission configuration information associated with the obtained organization identity.

The permission configuration information indicates an organization member having the first permission in an organization.

The form of the permission configuration information may be configured according to actual application scenarios. For example, the permission configuration information may include at least one of: a blacklist and a whitelist. The blacklist includes users not having the first permission. The whitelist includes users having the first permission.

The first permission indicates a permission for adding the organization to a group.

The permission configuration information may be configured by a user in charge of the organization. The permission configuration information may correspond to an organization to which the organization belongs. As an example, the company A includes a department B, and permission configuration information associated with the department B may be permission configuration information configured by a manager of the company A.

In step 403, the organization identity is displayed based on the first permission of the organization to which the current user belongs.

It should be noted that the organization identity is displayed based on the first permission of the current user, avoiding abuse of the function of adding the organization to the first group, and realizing risk control for the information security of the first group.

In some embodiments, the permission configuration information may be generated by performing configurations.

In some embodiments, the configurations may include: displaying a permission configuration page corresponding to the organization identity; and based on a selection operation for the group addition option, generating the permission configuration information corresponding to the organization identity.

The permission configuration page may include a group addition option. The group selection option may include at least one of: an everyone option, an organization leader option, an unmanned option, and a custom person option.

The everyone option may indicate that everyone has the first permission. The organization leader option may indicate that an organization leader has the first permission. The unmanned option may indicate that no member of the organization has the first permission. The custom person option is configured to define a specific person having the first permission.

As an example, after the custom personnel option is triggered, a selection control is provided for the user to select a specific person, so that the user may specify a specific person having the first permission.

It should be noted that by displaying the group addition option, the user may perform selection on the group addition option to configure permission, improving the convenience of configuring permission information and realizing rapid configuration and generation of permission configuration information.

In some embodiments, the configurations may include: displaying at least one of a blacklist region and a whitelist region.

The blacklist region is configured to display an identity of an organization member not having the first permission selected by the user.

The whitelist region is configured to display an identity of an organization member having the first permission selected by the user.

In some embodiments, the step of generating the permission configuration information corresponding to the organization identity based on a selection operation for a group addition option by: determining the permission configuration information based on at least one of: the selection operation for the group addition option, the identity of the organization member displayed in the blacklist region, and the identity of the organization member displayed in the whitelist region.

In an embodiment, in a case that the everyone option is selected, a blacklist function may be opened, that is, the user may input in the blacklist region; and in a case that the organization leader option or the unmanned option is selected, a whitelist function may be opened, that is, the user may input in the whitelist region.

In an embodiment, solutions for some conflict scenarios may be determined based on the group addition option and the priorities of the blacklist and the whitelist.

For example, in a case that the whitelist includes Zhang San and the unmanned option of the group addition option is selected, Zhang San may have the first permission if the whitelist has a high priority, and Zhang San may not have the first permission if the group addition option has a high priority.

For example, in a case that the blacklist includes Zhang San and the everyone option of the group addition option is selected, Zhang San may not have the first permission if the blacklist has a high priority, and Zhang San has the first permission if the group addition option has a high priority.

It should be noted that based on the group addition option and the blacklist and the whitelist, the permission configuration information is generated, conveniently and quickly configuring the permission configuration information, supplementing users that are missed by using the group addition option, improving the degree of compatibility between the configured first permission and actual requirements, and thereby improving the accuracy of the generated permission configuration information.

In some embodiments, the step 403 may include: displaying the organization identity of the organization to which the current user having the first permission belongs, and displaying a selection control corresponding to the organization identity.

The organization identity of the organization to which the current user having the first permission belongs and the selection control corresponding to the organization identity are displayed, showing the user a concise organization identity range, avoiding consuming display resources, facilitating the user performing selection in the concise organization identity range, and improving selection efficiency.

In some embodiments, the displaying the organization identity based on the first permission of the organization to which the current user belongs includes: displaying the organization identity of the organization to which the current user belongs, where the displayed organization identity includes at least one of: the organization identity of the organization for which the current user has the first permission and the organization identity of the organization for which the current user does not have the first permission; displaying a selection control corresponding to the organization identity of the organization for which the current user has the first permission; and for the organization identity of the organization for which the current user does not have the first permission, prompting, a predefined prompt mode, the current user does not have a permission to add an organization member associated with the organization identity to the group.

For the organization identity of the organization for which the current user has the first permission, the associated selection control may be displayed, thereby realizing the user selecting an organization.

For the organization identity of the organization for which the current user does not have the first permission, the current user may be prompted, in a predefined prompt mode, that the current user does not have the first permission.

It should be noted that the two organization identities of the organizations (for which the current user has the first permission and does not have the first permission respectively) are displayed differently, the user displaying the organization identity of the organization to which the user belongs, providing the user with an organization identity range, and prompting the user the permission on the organization identity for which the user does not have the first permission in the predefined prompt mode.

In some embodiments, the prompt mode includes at least one of: a mode in which the organization identity of the organization for which the current user does not have the first permission and the organization identity of the organization for which the current user has the first permission are distinguishably displayed in a predefined displaying mode; and a mode in which in response to detecting a triggering operation for the organization identity of the organization for which the current user does not have the first permission, prompting information is displayed.

For example, the organization identity of the organization for which the current user does not have the first permission is displayed in a grayed out display mode, distinguishing from the organization identity of the organization for which the current user has the first permission.

The prompt information indicates at least one of: that the current user does not have the permission to add an organization member associated with the organization identity to the group, that the current user has the permission to select an organization member and add the organization member to the group, and that the current user has a permission to apply for the first permission.

It should be noted that with the operation of distinguishably displaying the two organization identities of the organizations (for which the current user has the first permission and does not have the first permission respectively), the user displays the organization identity of the organization to which the user belongs, the user is provided with the organization identity range, and the user is prompted that the user cannot perform an operation on the organization identity for which the user does not have the first permission in the predefined displaying mode. In addition, in a case that the user, after knowing the organization to which the user belongs, wants to add the organization, for which the user does not have the first permission, to the first group, the user may apply for a permission in various ways, avoiding the confusion of the user about whether an error occurs in the application when the user wants to add an organization, to which the user belongs, to the first group and does not see an organization identity corresponding to the organization in displayed organization identities.

It should be noted that for the organization identity for which the current user does not have the first permission, the user may be prompted to select an organization member. For example, after an organization identity for which the current user does not have the first permission is triggered, the user is prompted that the user may select an organization member, thus the current user may add an expected organization member to the first group, ensuring the efficiency of information exchange in the first group.

It should be noted that for the organization identity for which the current user does not have the first permission, the current user may be prompted to apply for the first permission to the user having a permission granting capability. For example, after an organization identity for which the current user does not have the first permission is triggered, the current user is prompted to apply for the first permission to the user having the permission granting capability, thereby providing a way for the current user to activate the first permission. Thus, the current user adds organization members associated with the organization identity to the first group in bulk through the first permission, thereby improving the addition efficiency.

In some embodiments, the step 102 may include: in response to detecting a selection operation for an organization identity and detecting an addition confirmation operation, displaying a confirmation control; and in response to detecting a triggering operation for the confirmation control, determining an organization corresponding to the confirmation control as the group member unit of the first group.

The confirmation control is configured to confirm to the user whether to add the organization indicated by the organization identity to the first group. As an example, the confirmation control may display “Please confirm again whether to add organization A to the first group”.

It should be noted that the confirmation control is displayed, so that it is required for the user to make a secondary confirmation of adding an organization to the first group, avoiding the user from mistakenly adding the organization to the first group, thereby avoiding interference with other organization members in the organization, and ensuring the accuracy of the members of the first group without information leakage.

In some embodiments, the method further includes: displaying a revocation control corresponding to an organization identity of the group member unit of the first group; in response to detecting a trigger operation for the revocation control, disassociating a group member unit corresponding to a trigger control and the first group; and updating the first group members of the first group based on the disassociated group member unit.

A revocation control corresponding to a group member and/or a group member unit may be displayed in a group member display interface of the first group. The revocation control is configured to for the user to delete the group member or the group member unit from the first group.

It should be noted that with the configuration of the revocation control, a group member unit in the first group may be deleted timely when it is not suitable to remain the group member unit in the first group, ensuring that the group member unit of the first group meets a timing situation of group members required by the first group, and improving the accuracy of the group members of the first group and the information security of the first group. In addition, in the case of the user mistakenly adding an organization to the first group, loss can be stopped timely by using the revocation control.

It should be noted that the revocation control is configured to correspond to the organization identity, the user may delete group members in bulk when the user want to reduce the number of the group members, avoiding the users deleting the group members one by one, and thereby improving the operation efficiency.

In some embodiments, the updating the first group members of the first group based on the disassociated group member unit includes: determining, for an organization member associated with the disassociated group member unit, whether the organization member is added to the first group in a first addition mode, or is associated with a group member unit of the first group, or is added to the first group in a first addition mode and is associated with a group member unit of the first group; in a case that the organization member is added to the first group in the first addition mode, or is associated with the group member unit of the first group, or is added to the first group in the first addition mode and is associated with the group member unit of the first group, retaining the organization member in the first group; and in a case that the organization member is not added to the first group in the first addition mode and is not associated with the group member unit of the first group, deleting the organization member from the first group.

As an example, the organization A corresponds to a displayed revocation control. In a case that the user triggers the revocation control corresponding to the organization A, the association between the organization A and the first group may be released, that is, the qualification of the organization A as a group member unit of the first group is cancelled. In the first group, a deletion operation may be performed on an organization member of the organization A. The deletion operation may include: determining whether to delete an organization member from the first group based on a condition such as whether the organization member further belongs to another organization or whether the organization member is added to the first group in a single pulling mode.

It should be noted that after the revocation operation, it is further determined whether to delete an organization member from the first group. For the user added to the first group in multiple modes, it is verified from multiple aspects whether it is still required to remain the user in the first group, avoiding a situation in which the user cannot be interacted with in the first group due to that the user has been deleted.

Reference is made to FIG. 5, which shows a flow chart of an interaction method according to an embodiment of the present disclosure. As shown in FIG. 5, the interaction method includes the following steps 501 and 502.

In step 501, in response to detecting a predefined group member addition operation, a group candidate object is displayed.

The group candidate object may include an object that may be added to the first group.

In the embodiment, the group candidate object may include a user group identity. The user group identity indicates a user set including at least two users.

In step 502, based on a selection operation for the group candidate object, one or more selected user groups are determined, and a first group is generated based on the selected user groups.

In an embodiment, a group candidate object, such as a user group, selected by performing a selection operation may be determined as a group member unit of a first group. Then, group members of the user are determined as group members of the first group.

It should be noted that the user may select a group and then add the group, as a group member unit, to the first group. That is, group members are added with a group as a unit. Thus, groups may be effectively integrated, and transaction communication may be coordinated among several groups. For transactions required to be performed with a group as a unit, communication efficiency can be improved.

In addition, group members may be added in bulk by selecting a group, reducing operations due to individually selecting group members, saving the user the number of operations and time required to select candidate users in generating a group, and improving operation efficiency.

In some embodiments, at least two user group identities are selected. The step 502 may include: determining a union of users associated with the at least two selected user groups, and adding all users in the union to the first group.

As an example, a selected user group may include an organization A, an organization B, and a second group C. A union of users associated with the organization A, the organization B, and the second group C may be obtained. Then, all the users in the union are determined as first group members, thus the first group is generated.

It should be noted that the user union is determined based on multiple selected user groups, and then all the users in the union are added to the first group, avoiding duplicated users, avoiding a same user (such as a user A) from displaying multiple identity accounts (such as a user A in the organization A, a user A in the organization B, and a user A in the second group C) in the first group, avoiding confusion caused by displaying multiple identity accounts for a same user by the group members in the first group, improving the accuracy of the displayed information of the first group members, and thereby improving the efficiency of information exchange among the first group members.

In some embodiments, the user group identity may include at least one of: an organization identity and a second group identity.

The organization identity may indicate an organization structure.

The second group identity may indicate a group having a qualification to be added to a first organization.

The group includes an organization and/or a group. With the group, for various user sets of the current users, the user sets may be quickly added to the first group, improving the speed of adding group members to the first group.

In some embodiments, the step 502 includes: based on a selection operation for a group identity, determining a group indicated by the selection operation as a group member unit of the first group.

The group member unit is a management unit for managing first group members in the first group.

The group member unit may be a user unit to be added to the group. The group member unit may be a management unit for managing members in the first group. That is, the group member unit may be understood as a unit for managing users, and may add users or delete users in batches with the group member unit as a unit.

In some embodiments, the based on a selection operation for a group identity, determining a group indicated by the selection operation as a group member unit of the first group includes at least one of: based on detecting a selection operation for an organization identity, determining organization members associated with the organization identity as first group members of the first group; and based on detecting a selection operation for a second group identity, determining second group members associated with the second group identity corresponding to the selection operation as first group members of the first group.

As an example, the current user may select the organization A, the organization B, and the second group C. Thus, the organizations and the second group are mixed and added to the first group, performing information exchange between different types of groups, facilitating task collaboration and information exchange between different types of groups, thereby improving the efficiency of information exchange in the second group.

In some embodiments, the step of updating the first group members in the first group based on updating the group members associated with the group member unit may include: in response to adding a group member to the group members associated with group member unit, determining the added group member as a first group member of the first group.

As an example, in a case that a group member Ma Ba is added to a group A, Ma Ba may be added to the first group.

As an example, in a case that a group member Zhang San is added to a group C, Zhang San may be determined as a group member, and then it is determined whether Zhang San is already in the first group. If Zhang San is not in the first group, Zhang San may be determined as a group member. If Zhang San is already in the first group, it is unnecessary to add Zhang San to the first group.

It should be noted that when adding a new member to a group, the group members in the first group are synchronously updated, thereby automatically updating the first group based on the newly added member in the group.

In some embodiments, the step of updating the first group members in the first group based on updating the group members associated with the group member unit may include: in response to deleting a group member from the group members associated with group member unit, determining whether to delete the deleted group member from the first group based on the group member unit of the first group associated with the deleted group member.

As an example, in a case that a user Zhang San is deleted from a group A, it may be determined whether to delete Zhang San from the first group based on the group member unit of the first group associated with Zhang San.

It should be noted that when deleting a member from a group, based on the group member unit associated with the deleted member, it may be determined from multiple perspectives whether to remain the deleted user, that is added to the first group in multiple modes, in the first group, avoiding a situation in which a user cannot be interacted with in the first group due to that the user has been deleted.

In some embodiments, the step of in response to deleting an organization member from the organization members associated with group member unit, determining whether to delete the deleted organization member from the first group based on the group member unit of the first group associated with the deleted organization member includes: in response to determining that the deleted group member is associated with a group member unit of the first group, retaining the deleted group member in the first group.

As an example, Zhang San may be added to a group through the group A and the group C. In a case that Zhang San has been deleted from the group A and Zhang San is still in the group C, if the group C is still a group member unit of the first group, Zhang San may be retained in the first group.

It should be noted that in a case that a deleted group member is associated with a group member of the first group, the deleted group member is not deleted, avoiding a situation in which the deleted member is deleted from the first group while the deleted member is still in a group member unit of the first group. Thus, the accuracy of the group members in the first group is ensured.

In some embodiments, the step of in response to deleting a group member from the group members associated with group member unit, determining whether to delete the deleted group member from the first group based on the group member unit of the first group associated with the deleted group member includes: in response to determining that the deleted group member is not associated with a group member unit of the first group, determining whether the deleted group member is added to the first group in a first addition mode; in a case that the deleted group member is added to the first group in the first addition mode, retaining the deleted group member in the first group; and in a case that the deleted group member is not added to the first group in the first addition mode, deleting the deleted group member from the first group.

As an example, in a case that the group C is no longer a group member unit of the first group, that is, Zhang San is not associated with a group member unit of the first group, it may be determined whether Zhang San is added to the first group in a first addition mode. In a case that Zhang San is not added to the first group in the first addition mode, Zhang San may be deleted from the first group.

It should be noted that in a case that a user is not added to a group in the first addition mode and does not belong to any group member unit of the first group, it indicates that it is unnecessary to keep the user in the first group. In this case, the user should be deleted from the first group, preventing information leakage from the first group.

It should be noted that in a case that a user does not belong to any group member unit of the first group and the user is added to the group in the first addition mode, it indicates, by the addition mode of the user, that even if the user is deleted from the group, the user should still remained in the first group. Therefore, in this case, the user should be remained in the first group, avoiding inefficient information exchange in the first group due to the user being unable to participate in the first group.

In some embodiments, the step of in response to deleting a group member from the group members associated with group member unit, determining whether to delete the deleted group member from the first group based on the group member unit of the first group associated with the deleted group member includes: in response to deleting the group member from the group members associated with group member unit, determining whether the deleted group member is added to the first group in a first addition mode; in a case that the deleted group member is added to the first group in the first addition mode, retaining the deleted group member in the first group; and in a case that the deleted group member is not added to the first group in the first addition mode, determining whether to delete the deleted group member from the first group based on the group member unit of the first group associated with the deleted group member.

As an example, Zhang San is deleted from the group A. Then, it may be determined whether Zhang San is added to the first group in a first addition mode. In a case that Zhang San is added to the first group in the first addition mode, Zhang San is remained in the first group. In a case that Zhang San is not added to the first group in the first addition mode, it is determined whether Zhang San is associated with a group (such as group C) in the first group.

Therefore, a step of comparing a deleted group member with each of group member units can be omitted, and it is quickly determined whether to delete the deleted group member from the first group.

In some embodiments, the first addition mode in which a member is added to the first group includes at least one of: a mode in which a member is added to the first group based on selecting a user identity; and a mode in which based on selecting a second group identity, a second group member associated with the second group identity is added to the first group.

The mode in which a member is added to the first group based on selecting a user identity may be understood as adding a member to the first group in a single pulling mode. As an example, a current user may check the identity of Zhang San to add Zhang San to the first group.

The mode in which based on selecting a second group identity, a second group member associated with the second group identity is added to the first group may be understood as adding a member to the first group by selecting a group. As an example, a current user may check a second group identity, and then all members corresponding to the second group identity may be added to the first group.

It should be noted that adding a member to a group in the first addition mode may reflect diversity of adding users to the first group. The user, being added to the first group in multiple modes, may be necessary for the first group. Therefore, the first addition mode is verified to avoid mistakenly deleting an important first group member.

In some embodiments, the step 501 may include: in response to detecting the predefined group member addition operation, displaying a second group identity based on a predetermined time condition.

The predetermined time condition indicates a second group having message interaction in a predetermined time period.

The user may be presented with groups having message interactions in a predetermined time period (such as in a day), thereby filtering out groups remaining silent for a long time.

It should be noted that compared to the second group remaining silent, the second group having message interaction in the predetermined time period has a high probability of being an object to be added to the first group by the user. A group identity of a group having a high probability is displayed, omitting the step of the user searching for a second group, reducing the operations of the user, and improving the efficiency of the user adding a group member to the first group.

In some embodiments, the step 501 may include: based on a target search term, searching for a communication object matching the target search term in communication objects of a current user; and displaying a searched communication object as a group candidate object.

The communication objects of the current user include at least one of, but are not limited to: an organization identity, a second group identity, and a user identity.

The user searches for an object to be added to the first group, and various forms of candidate communication objects may be displayed.

As an example, the user may use Zhang San as a search term. The user may search for a candidate communication object matching Zhang San in the communication objects of the user. For example, the searched candidate communication object may include the user Zhang San, an organization A to which Zhang San belongs, and a group A to which Zhang San belongs. The current user may select the organization A to which Zhang San belongs, then the organization A may be determined as the group member unit of the group, and then the organization members of the group member unit may be determined as the group members of the first group.

It should be noted that multiple types of candidate communication objects may be searched in a mixed search way, a wide range of candidate objects related to a search term may be displayed to the user, and the probability of the user obtaining a desired object in the displayed search results increases in a case of a wide range of selectable objects, omitting the step for the user to search again or view communication records to add a member, reducing the operations of the user, and improving the speed of adding members to the first group.

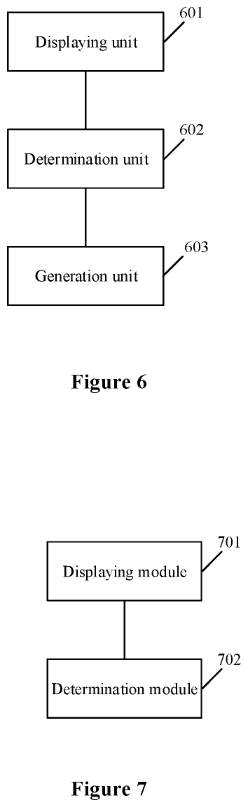

Further referring to FIG. 6, as an implementation of the method shown in the above Figures, an interaction apparatus is provided according to an embodiment of the present disclosure. The apparatus embodiments correspond to the method embodiments shown in FIG. 1. The apparatus may be applied to various electronic devices.

As shown in FIG. 6, the interaction apparatus in the embodiment includes: a displaying unit 601, a determination unit 602, and a generation unit 603. The displaying unit is configured to display one or more organization identity in response to detecting a predefined group member addition operation, where the organization identity indicates an organization structure. The determination unit is configured to, based on a selection operation for the organization identity, determine a group member unit for a first group, where the group member unit is a management unit for managing first group members in the first group. The generation unit is configured to, based on the determined group member unit, generate the first group, where the first group members of the first group include organization members associated with the group member unit.

The specific processing and the corresponding technical effects of the displaying unit 601, the determination unit 602, and the generation unit 603 of the interaction apparatus in the embodiment may refer to the descriptions of steps 101, 102, and 103 in the corresponding embodiments shown in FIG. 1, and are not repeated herein.

In some embodiments, the first group is generated based on the determined group member unit by: adding all the organization members associated with the determined group member unit to the first group.

In some embodiments, the method further includes: updating the first group members in the first group based on updating the organization members associated with the group member unit.

In some embodiments, the first group members in the first group are updated based on updating the organization members associated with the group member unit by: in response to adding an organization member to the organization members associated with group member unit, determining the added organization member as a first group member of the first group.

In some embodiments, the first group members in the first group are updated based on updating the organization members associated with the group member unit by: in response to deleting an organization member from the organization members associated with group member unit, determining whether to delete the deleted organization member from the first group based on the group member unit of the first group associated with the deleted organization member.

In some embodiments, in response to deleting an organization member from the organization members associated with group member unit, it is determined whether to delete the deleted organization member from the first group based on the group member unit of the first group associated with the deleted organization member by: in response to determining that the deleted organization member is associated with a remaining group member unit of the first group, retaining the deleted organization member in the first group.

In some embodiments, in response to deleting an organization member from the organization members associated with group member unit, it is determined whether to delete the deleted organization member from the first group based on the group member unit of the first group associated with the deleted organization member by: in response to determining that the deleted organization member is not associated with a group member unit of the first group, determining whether the deleted organization member is added to the first group in a first addition mode; in a case that the deleted organization member is added to the first group in the first addition mode, retaining the deleted organization member in the first group; and in a case that the deleted organization member is not added to the first group in the first addition mode, deleting the deleted organization member from the first group.

In some embodiments, in response to deleting an organization member from the organization members associated with group member unit, it is determined whether to delete the deleted organization member from the first group based on the group member unit of the first group associated with the deleted organization member by: in response to deleting the organization member from the organization members associated with group member unit, determining whether the deleted organization member is added to the first group in a first addition mode; and in a case that the deleted organization member is added to the first group in the first addition mode, retaining the deleted organization member in the first group.

In some embodiments, the first addition mode in which a member is added to the first group includes at least one of: a mode in which a member is added to the first group based on selecting a user identity; and a mode in which based on selecting a second group identity, a second group member associated with the second group identity is added to the first group.

In some embodiments, the method further includes at least one of: determining a trigger operation for a group generation control as the group member addition operation;

determining a new member search operation for a generated group as the group member addition operation; and determining a new member addition operation for the generated group as the group member addition operation.

In some embodiments, based on the determined group member unit, the first group is generated by at least one of: generating the first group; and adding a new first group member to a generated first group.

In some embodiments, in response to detecting the predefined group member addition operation, the organization identity is displayed by: obtaining an organization identity of an organization to which a current user belongs; determining whether the current user has a first permission based on permission configuration information associated with the obtained organization identity, where the permission configuration information indicates an organization member having the first permission in an organization, and the first permission indicates a permission for adding the organization to a group; and displaying the organization identity based on the first permission of the organization to which the current user belongs.

In some embodiments, the permission configuration information is configured by:

displaying a permission configuration page corresponding to the organization identity, where the permission configuration page includes a group addition option, and the group addition option includes at least one of: an everyone option, an organization leader option, an unmanned option, and a custom person option; based on a selection operation for the group addition option, generating the permission configuration information corresponding to the organization identity.

In some embodiments, the permission configuration information is configured by: displaying at least one of: a blacklist region and a whitelist region, where the blacklist region is configured to display an identity of an organization member not having the first permission selected by the user, and the whitelist region is configured to display an identity of an organization member having the first permission selected by the user; and the permission configuration information corresponding to the organization identity is generated based on a selection operation for a group addition option by: generating the permission configuration information based on at least one of: the selection operation for the group addition option, the identity of the organization member displayed in the blacklist region, and the identity of the organization member displayed in the whitelist region.

In some embodiments, the organization identity is displayed based on the first permission of the organization to which the current user belongs by: displaying the organization identity of the organization to which the current user having the first permission belongs, and displaying a selection control corresponding to the organization identity.

In some embodiments, the organization identity is displayed based on the first permission of the organization to which the current user belongs by: displaying the organization identity of the organization to which the current user belongs, where the displayed organization identity includes at least one of: the organization identity of the organization for which the current user has the first permission and the organization identity of the organization for which the current user does not have the first permission; displaying a selection control corresponding to the organization identity of the organization for which the current user has the first permission; and for the organization identity of the organization for which the current user does not have the first permission, prompting, a predefined prompt mode, the current user does not have a permission to add an organization member associated with the organization identity to the group.

In some embodiments, the prompt mode includes at least one of: a mode in which the organization identity of the organization for which the current user does not have the first permission and the organization identity of the organization for which the current user has the first permission are distinguishably displayed in a predefined displaying mode; and a mode in which in response to detecting a triggering operation for the organization identity of the organization for which the current user does not have the first permission, prompting information is displayed, where the prompt information indicates at least one of: that the current user does not have the permission to add an organization member associated with the organization identity to the group, that the current user has the permission to select an organization member and add the organization member to the group, and that the current user has a permission to apply for the first permission.

In some embodiments, the method further includes: displaying a revocation control corresponding to an organization identity of the group member unit of the first group; in response to detecting a trigger operation for the revocation control, disassociating a group member unit corresponding to a trigger control and the first group; and updating the first group members of the first group based on the disassociated group member unit.

In some embodiments, the first group members of the first group are updated based on the disassociated group member unit by: determining, for an organization member associated with the disassociated group member unit, whether the organization member is added to the first group in a first addition mode, or is associated with a group member unit of the first group, or is added to the first group in a first addition mode and is associated with a group member unit of the first group; in a case that the organization member is added to the first group in the first addition mode, or is associated with the group member unit of the first group, or is added to the first group in the first addition mode and is associated with the group member unit of the first group, retaining the organization member in the first group; and in a case that the organization member is not added to the first group in the first addition mode and is not associated with the group member unit of the first group, deleting the organization member from the first group.

Further referring to FIG. 7, as an implementation of the method shown in the above Figures, an interaction apparatus is provided according to an embodiment of the present disclosure. The apparatus embodiments correspond to the method embodiments shown in FIG. 1. The apparatus may be applied to various electronic devices.

As shown in FIG. 7, the interaction apparatus in the embodiment includes: a displaying module 701 and a determination module 702. The displaying module is configured to, in response to detecting a predefined group member addition operation, display a group candidate object, where the group candidate object includes a user group identity, and the user group identity indicates a user set including at least two users. The determination module is configured to, based on a selection operation for the group candidate objects, determine one or more selected user groups, and generate a first group based on the selected user groups.

The specific processing and the corresponding technical effects of the displaying module 701 and the determination module 702 of the interaction apparatus in the embodiment may refer to the descriptions of steps 501 and 502 in the corresponding embodiments shown in FIG. 5, and are not repeated herein.

In some embodiments, at least two user group identities are selected. The first group is generated based on the selected user groups by: determining a union of users associated with the at least two selected user groups, and adding all users in the union to the first group.

In some embodiments, the user group identity includes at least one of: an organization identity and a second group identity. The organization identity indicates an organization structure.

In some embodiments, based on the selection operation for the group candidate objects, one or more selected user groups are determined and the first group is generated based on the selected user groups by: based on a selection operation for a group identity, determining a group indicated by the selection operation as a group member unit of the first group, where the group member unit is a management unit for managing first group members in the first group.

In some embodiments, based on the selection operation for the group identity, a group indicated by the selection operation is determined as the group member unit of the first group by at least one of: based on detecting a selection operation for an organization identity, determining organization members associated with the organization identity as first group members of the first group; and based on detecting a selection operation for a second group identity, determining second group members associated with the second group identity corresponding to the selection operation as first group members of the first group.

In some embodiments, in response to detecting the predefined group member addition operation, the group candidate object is displayed by: in response to detecting the predefined group member addition operation, displaying a second group identity based on a predetermined time condition, where the predetermined time condition indicates a second group having message interaction in a predetermined time period.

In some embodiments, in response to detecting the predefined group member addition operation, the group candidate object is displayed by: based on a target search term, searching for a communication object matching the target search term in communication objects of a current user, where the communication objects of the current user includes at least one of: an organization identity, a second group identity, and a user identity; and displaying a searched communication object as a group candidate object.

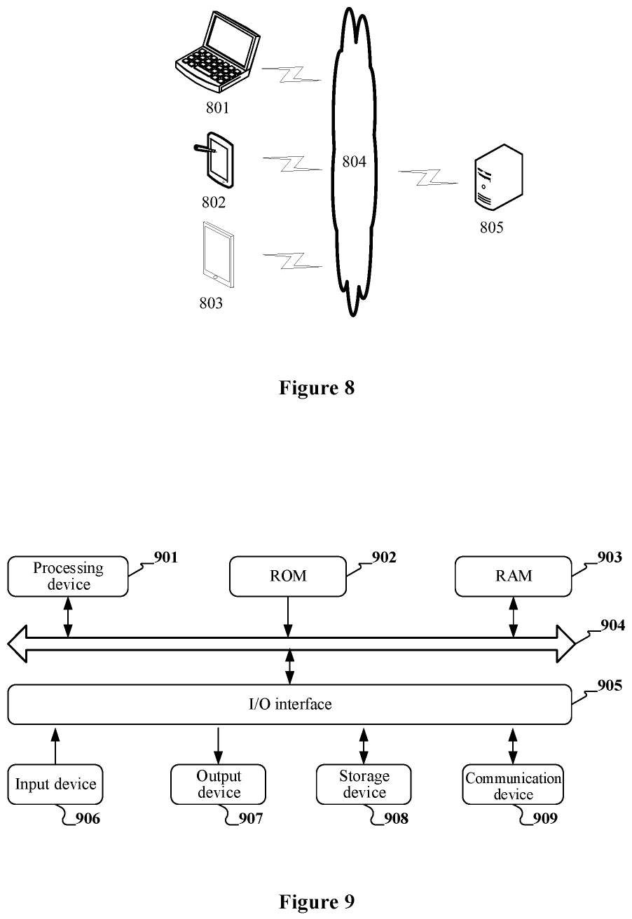

Reference is further made to FIG. 8, which shows an exemplary system architecture to which an interaction method according to an embodiment of the present disclosure may be applied.

As shown in FIG. 8, the system architecture may include terminal devices 801, 802 and 803, a network 804, and a server 805. The network 804 configured to provide a medium for communication links between the terminal devices 801, 802, 803 and the server 805. The network 804 may include various connections, such as connections based on wired communication links, connections based on wireless communication links, or connections based on fiber optic cables.

The terminal devices 801, 802, and 803 may communicate with the server 805 via the network 804 to receive or transmit messages. Various client applications, such as web browser applications, search applications, and news information applications, may be installed on the terminal devices 801, 802 and 803. The client applications installed on the terminal devices 801, 802, and 803 may receive an instruction from the user, and perform a function based on the instruction from the user, such as adding information based on the instruction from the user.

The terminal devices 801, 802, and 803 may be in a form of hardware or software. In a case that the terminal devices 801, 802, and 803 are in a form of hardware, the terminal devices 801, 802, and 803 may be various electronic devices that have a display screen and support web browsing, including but not limited to smart phones, tablet computers, e-book readers, MP3 (Moving Picture Experts Group Audio Layer III) players, MP4 (Moving Picture Experts Group Audio Layer IV) players, laptops and desktops. In a case that the terminal devices 801, 802, and 803 are in a form of software, the terminal devices 801, 802, and 803 may be installed in the electronic devices listed above. The terminal devices 801, 802, and 803 may be implemented as multiple software or software modules (such as software or software modules for providing distributed services), or may be implemented as a single software or software module, which is not limited herein.

The server 805 may provide various services. For example, the server 805 may receive information acquisition requests from the terminal devices 801, 802, and 803, obtain display information corresponding to the information acquisition request in various ways based on the information acquisition request, and transmit data of the display information to the terminal devices 801, 802, and 803.

It should be noted that the interaction method according to the embodiments of the present disclosure may be performed by a terminal device, and the interaction apparatus may be arranged in the terminal devices 801, 802, and 803. In addition, the interaction method according to the embodiments of the present disclosure may be performed by the server 805, and the interaction apparatus may be arranged in the server 805.

It should be understood that the numbers of terminal devices, networks and servers in FIG. 8 are only illustrative, and any number of numbers of terminal devices, networks and servers may be configured according to implementation requirements.

Hereinafter, reference is made to FIG. 9, which shows a schematic structural diagram of an electronic device (such as the terminal device or the server shown in FIG. 8) suitable for implementing the embodiments of the present disclosure. The terminal devices according to the embodiments of the present disclosure may include, but are not limited to, mobile terminals, such as mobile phones, laptops, digital broadcast receivers, PDAs (personal digital assistants), PADs (tablet PCs), PMPs (portable multimedia players) and vehicle-mounted terminals (such as in-vehicle navigation terminals), and fixed terminals such as digital TVs and desktop computers. The electronic device shown in FIG. 9 is only exemplary, and should not indicate any limitation to the function and application scope of the embodiments of the present disclosure.

As shown in FIG. 9, the electronic device may include a processing device 901 (such as a central processor and a graphics processor) which may execute various operations and processing through a program stored in a Read Only Memory (ROM) 902 or a program loaded from the storage device 908 into a Random Access Memory (RAM) 903. The RAM 903 is further configured to store various programs and data required by the electronic device 900. The processing device 901, the ROM 902 and the RAM 903 are connected to each other through a bus 904. An Input/output (I/O) interface 905 is also connected to the bus 904.

Generally, the I/O interface 905 may be connected to: an input device 906, such as a touch screen, a touch panel, a keyboard, a mouse, a camera, a microphone, an accelerometer, and a gyroscope; an output device 907, such as a liquid crystal display (LCD), a speaker, and a vibrator; a storage device 908 such as a magnetic tape, a hard disk, and a memory card; and a communication device 909. The communication device 909 enables the electronic device to perform wireless or wired communication with other devices for data exchanging. Although FIG. 9 shows an electronic device having various components, it should be understood that the illustrated components are not necessarily required to all be implemented or included. Alternatively, more or fewer components may be implemented or included.

Particularly, according to some embodiments of the present disclosure, the process described above in conjunction with flow charts may be implemented as a computer software program. For example, a computer program product is further provided according to some embodiments of the present disclosure, including a computer program carried on a computer readable medium. The computer program includes program codes for performing the method shown in the flow charts. In the embodiments, the computer program may be downloaded and installed from the network via the communication device 909, or installed from the storage device 908, or installed from the ROM 902. When the computer program is executed by the processing device 901, the above-mentioned functions defined in the method according to the embodiments of the present disclosure are performed.

It should be noted that, the computer readable medium mentioned herein may be a computer readable signal medium or a computer readable storage medium or any combination thereof. The computer readable storage medium may be, but is not limited to, a system, an apparatus, or a device in an electronic, magnetic, optical, electromagnetic, infrared, or semi-conductive form, or any combination thereof. The computer readable storage medium may be, but is not limited to, an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), a light storage device, a magnetic storage device or any combination thereof. In some embodiments of the present disclosure, the computer readable storage medium may be any tangible medium containing or storing a program, and the program may be used by or in combination with an instruction execution system, apparatus, or device. In some embodiments of the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may be any computer readable medium other than the computer readable storage medium and can send, propagate or transmit programs to be used by or with an instruction execution system, apparatus or device. The program codes stored in the computer readable medium may be transmitted via any proper medium including but not limited to: wired, optical fiber cable, radio frequency (RF), or any suitable combination of the foregoing.

In some embodiments, the client and the server may perform communication using any currently known or future developed network protocol such as HTTP (HyperText Transfer Protocol), and may be interconnected with any form or medium of digital data communication (for example, a communication network). The communication network embodiments include local area networks (“LANs”), wide area networks (“WANs”), internet, end-to-end networks (for example, ad hoc end-to-end networks), and any networks currently known or developed in the future.

The computer readable medium may be incorporated in the electronic device, or may exist alone without being assembled into the electronic device.

The computer readable medium carries one or more programs. The one or more programs, when being executed by the electronic device, cause the electronic device to: in response to detecting a predefined group member addition operation, display one or more organization identity, where the organization identity indicates an organization structure;

based on a selection operation for the organization identity, determine a group member unit for a first group, where the group member unit is a management unit for managing first group members in the first group; and based on the determined group member unit, generate the first group, where the first group members of the first group include organization members associated with the group member unit.

The computer readable medium carries one or more programs. The one or more programs, when being executed by the electronic device, cause the electronic device to: in response to detecting a predefined group member addition operation, display a group candidate object, where the group candidate object includes a user group identity, and the user group identity indicates a user set including at least two users; and based on a selection operation for the group candidate object, determine one or more selected user groups, and generate a first group based on the selected user groups.

Computer program code for performing operations of the present disclosure may be written in one or more programming languages, or a combination of the foregoing, and the programming language includes, but is not limited to, object oriented programming languages, such as Java, Smalltalk, and C++, also includes conventional procedural programming languages, such as “C” language or similar programming languages. The program codes may be executed entirely on a user's computer, or be executed partly on the user's computer, or be executed as a stand-alone software package, or be executed partly on the user's computer and partly on a remote computer, or be executed entirely on the remote computer or server. In a case that the execution of the program code involves a remote computer, the remote computer may be connected to a user's computer via any kind of network, including a local area network (LAN) or a wide area network (WAN), or may be connected to an external computer (for example, via an Internet providing by an Internet service provider).

The flow charts and block diagrams in the Figures shows the architecture, functionality and operation of possible implementations of the products of system, method and computer program provided according to the embodiments of the present disclosure. Each block in the flow charts or block diagrams can represent a module, a program segment, or a part of codes, and the module, the program segment, or the part of code includes one or more executable instructions for implementing specified logical functions. It should be noted that in some alternative implementations, the functions noted in the blocks may be implemented in a different order than those illustrated in the Figures. For example, two blocks shown in succession may in fact be executed substantially in parallel, and they may sometimes be executed in a reverse order, depending upon the functionality involved. It also should be noted that each block in the block diagrams and/or flow charts, and combinations of blocks in the block diagrams and/or flowcharts, can be implemented by a dedicated hardware-based system which is configured to implement specified functions or operations, or can be implemented by using a combination of dedicated hardware and computer instructions.

The units mentioned in the description of the embodiments of the present disclosure may be implemented by means of software, or otherwise by means of hardware. The designation of these units does not in any case constitute a qualification of the unit itself. For example, the displaying unit may also be described as “a unit that displays an organization identity”.

The functions described above in this application may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD), and so on.

In the present disclosure, a machine-readable medium may be a tangible medium, which may contain or store a program used by the instruction execution system, apparatus, or device or a program used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of thereof. The machine-readable storage media, for example, includes an electrical connection based on one or more wires, a portable computer disk, a hard drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of thereof.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

In addition, although the operations are described in a specific order, it should not be understood that these operations are to be performed in the specific order shown or performed in a sequential order. Under certain circumstances, multitasking and parallel processing may be advantageous. Although the specific implementation details are described above, these implementation details should not be construed as limiting the scope of the present disclosure. The features described in multiple separate embodiments may be implemented in combination in a separate embodiment. Conversely, the features described in a separate embodiment may be implemented in multiple embodiments individually or in any suitable sub-combination.

Although the subject matter has been described in language specific to structural features and/or logical actions of the method, it should be understood that the subject matter defined in the appended claims are unnecessarily limited to the specific features or actions described above. The specific features and actions described above are merely exemplary forms of implementing the claims.

1. An interaction method, comprising:
in response to detecting a predefined group member addition operation, displaying one or more organization identity, wherein the organization identity indicates an organization structure;
based on a selection operation for the organization identity, determining a group member unit for a first group, wherein the group member unit is a management unit for managing first group members in the first group; and
based on the determined group member unit, generating the first group, wherein the first group members of the first group comprise organization members associated with the group member unit.

2. The method according to claim 1, wherein the based on the determined group member unit, generating the first group comprises at least one of:
adding all the organization members associated with the determined group member unit to the first group;
generating the first group; and
adding a new first group member to a generated first group.

3. The method according to claim 1, further comprising:
updating the first group members in the first group based on updating the organization members associated with the group member unit.

4. The method according to claim 3, wherein the updating the first group members in the first group based on updating the organization members associated with the group member unit comprises:
in response to adding an organization member to the organization members associated with group member unit, determining the added organization member as a first group member of the first group.

5. The method according to claim 3, wherein the updating the first group members in the first group based on updating the organization members associated with the group member unit comprises:
in response to deleting an organization member from the organization members associated with group member unit, determining whether to delete the deleted organization member from the first group based on the group member unit of the first group associated with the deleted organization member.

6. The method according to claim 5, wherein the in response to deleting an organization member from the organization members associated with group member unit, determining whether to delete the deleted organization member from the first group based on the group member unit of the first group associated with the deleted organization member comprises:
in response to determining that the deleted organization member is associated with a remaining group member unit of the first group, retaining the deleted organization member in the first group.

7. The method according to claim 5, wherein the in response to deleting an organization member from the organization members associated with group member unit, determining whether to delete the deleted organization member from the first group based on the group member unit of the first group associated with the deleted organization member comprises:
in response to determining that the deleted organization member is not associated with a group member unit of the first group, determining whether the deleted organization member is added to the first group in a first addition mode;
in a case that the deleted organization member is added to the first group in the first addition mode, retaining the deleted organization member in the first group; and
in a case that the deleted organization member is not added to the first group in the first addition mode, deleting the deleted organization member from the first group;
or,
in response to deleting the organization member from the organization members associated with group member unit, determining whether the deleted organization member is added to the first group in a first addition mode; and
in a case that the deleted organization member is added to the first group in the first addition mode, retaining the deleted organization member in the first group.

8. The method according to claim 7, wherein the first addition mode in which a member is added to the first group comprises at least one of:
a mode in which a member is added to the first group based on selecting a user identity; and
a mode in which based on selecting a second group identity, a second group member associated with the second group identity is added to the first group.

9. The method according to claim 1, further comprising at least one of:
determining a trigger operation for a group generation control as the group member addition operation;
determining a new member search operation for a generated group as the group member addition operation; and
determining a new member addition operation for the generated group as the group member addition operation.

10. The method according to claim 1, wherein the in response to detecting a predefined group member addition operation, displaying one or more organization identity comprises:
obtaining an organization identity of an organization to which a current user belongs;
determining whether the current user has a first permission based on permission configuration information associated with the obtained organization identity, wherein the permission configuration information indicates an organization member having the first permission in an organization, and the first permission indicates a permission for adding the organization to a group; and
displaying the organization identity based on the first permission of the organization to which the current user belongs.

11. The method according to claim 10, wherein the permission configuration information is configured by:
displaying a permission configuration page corresponding to the organization identity, wherein the permission configuration page comprises a group addition option, and the group addition option comprises at least one of: an everyone option, an organization leader option, an unmanned option, and a custom person option;
based on a selection operation for the group addition option, generating the permission configuration information corresponding to the organization identity, or,
displaying at least one of: a blacklist region and a whitelist region, wherein the blacklist region is configured to display an identity of an organization member not having the first permission selected by a user, and the whitelist region is configured to display an identity of an organization member having the first permission selected by a user; and
the permission configuration information corresponding to the organization identity is generated based on a selection operation for a group addition option comprises:
generating the permission configuration information based on at least one of: the selection operation for the group addition option, the identity of the organization member displayed in the blacklist region, and the identity of the organization member displayed in the whitelist region.

12. The method according to claim 10, wherein the displaying the organization identity based on the first permission of the organization to which the current user belongs comprises:
displaying the organization identity of the organization to which the current user having the first permission belongs, and displaying a selection control corresponding to the organization identity.

13. The method according to claim 10, wherein the displaying the organization identity based on the first permission of the organization to which the current user belongs comprises:
displaying the organization identity of the organization to which the current user belongs, wherein the displayed organization identity comprises at least one of: the organization identity of the organization for which the current user has the first permission and the organization identity of the organization for which the current user does not have the first permission;
displaying a selection control corresponding to the organization identity of the organization for which the current user has the first permission; or
for the organization identity of the organization for which the current user does not have the first permission, prompting, a predefined prompt mode, the current user does not have a permission to add an organization member associated with the organization identity to the group.

14. The method according to claim 13, wherein the prompt mode comprises at least one of:
a mode in which the organization identity of the organization for which the current user does not have the first permission and the organization identity of the organization for which the current user has the first permission are distinguishably displayed in a predefined displaying mode; and
a mode in which in response to detecting a triggering operation for the organization identity of the organization for which the current user does not have the first permission, prompting information is displayed, wherein the prompt information indicates at least one of: that the current user does not have the permission to add an organization member associated with the organization identity to the group, that the current user has the permission to select an organization member and add the organization member to the group, and that the current user has a permission to apply for the first permission.

15. The method according to claim 1, further comprising:
displaying a revocation control corresponding to an organization identity of the group member unit of the first group;
in response to detecting a trigger operation for the revocation control, disassociating a group member unit corresponding to a trigger control and the first group; and
updating the first group members of the first group based on the disassociated group member unit.

16. The method according to claim 15, wherein the updating the first group members of the first group based on the disassociated group member unit comprises:
determining, for an organization member associated with the disassociated group member unit, whether the organization member is added to the first group in a first addition mode, or is associated with a group member unit of the first group, or is added to the first group in a first addition mode and is associated with a group member unit of the first group;
in a case that the organization member is added to the first group in the first addition mode, or is associated with the group member unit of the first group, or is added to the first group in the first addition mode and is associated with the group member unit of the first group, retaining the organization member in the first group; and
in a case that the organization member is not added to the first group in the first addition mode and is not associated with the group member unit of the first group, deleting the organization member from the first group.

17. An interaction method, comprising:
in response to detecting a predefined group member addition operation, displaying a group candidate object, wherein the group candidate object comprises a user group identity, and the user group identity indicates a user set comprising at least two users; and
based on a selection operation for the group candidate object, determining one or more selected user groups, and generating a first group based on the selected user groups.

18. The method according to claim 17, wherein
at least two user group identities are selected; and
the generating a first group based on the selected user groups comprises:
determining a union of users associated with the at least two selected user groups, and adding all users in the union to the first group;
or,
wherein, the user group identity comprises at least one of: an organization identity and a second group identity, and the organization identity indicates an organization structure.

19. The method according to claim 17, wherein the based on a selection operation for the group candidate objects, determining one or more selected user groups, and generating a first group based on the selected user groups comprises:
based on a selection operation for a group identity, determining a group indicated by the selection operation as a group member unit of the first group, wherein the group member unit is a management unit for managing first group members in the first group.

20. The method according to claim 19, wherein the based on a selection operation for a group identity, determining a group indicated by the selection operation as a group member unit of the first group comprises at least one of:
based on detecting a selection operation for an organization identity, determining organization members associated with the organization identity as first group members of the first group; and
based on detecting a selection operation for a second group identity, determining second group members associated with the second group identity corresponding to the selection operation as first group members of the first group.

21. The method according to claim 20, wherein the in response to detecting a predefined group member addition operation, displaying a group candidate object comprises:
in response to detecting the predefined group member addition operation, displaying a second group identity based on a predetermined time condition, wherein the predetermined time condition indicates a second group having message interaction in a predetermined time period, or,
based on a target search term, searching for a communication object matching the target search term in communication objects of a current user, wherein the communication objects of the current user comprises at least one of: an organization identity, a second group identity, and a user identity; and
displaying a searched communication object as a group candidate object.

22. An electronic device, comprising:
at least one processor; and
at least one memory communicatively coupled to the at least one processor and storing instructions that upon execution by the at least one processor cause the apparatus to:
in response to detecting a predefined group member addition operation, display an organization identity, wherein the organization identity indicates an organization structure;
based on a selection operation for the organization identity, determine a group member unit for a first group, wherein the group member unit is a management unit for managing first group members in the first group; and
based on the determined group member unit, generate the first group, wherein the first group members of the first group comprise organization members associated with the group member unit;
or,
in response to detecting a predefined group member addition operation, display a group candidate object, wherein the group candidate object comprises a user group identity, and the user group identity indicates a user set comprising at least two users; and
based on a selection operation for the group candidate object, determine one or more selected user groups, and generating a first group based on the selected user groups.

23. A computer-readable non-transitory medium, bearing computer-readable instructions that upon execution on a computing device cause the computing device at least to:
in response to detecting a predefined group member addition operation, display an organization identity, wherein the organization identity indicates an organization structure;
based on a selection operation for the organization identity, determine a group member unit for a first group, wherein the group member unit is a management unit for managing first group members in the first group; and
based on the determined group member unit, generate the first group, wherein the first group members of the first group comprise organization members associated with the group member unit;
or,
in response to detecting a predefined group member addition operation, display a group candidate object, wherein the group candidate object comprises a user group identity, and the user group identity indicates a user set comprising at least two users; and
based on a selection operation for the group candidate object, determine one or more selected user groups, and generating a first group based on the selected user groups.
